(19) United States
(12) Patent Application Publication
(10) Pub. No.: US 2022/0038931 A1
(43) Pub. Date: Feb. 3, 2022

(54) RADIO LINK ADAPTATION IN WIRELESS NETWORK

(71) Applicant: Nokia Technologies Oy, Espoo (FI)

(72) Inventors: Lauri Ilari KURU, Espoo (FI); Antti Anton TOSKALA, Espoo (FI); Jani Matti Johannes MOILANEN, Helsinki (FI); Zexian LI, Espoo (FI); Teemu Mikael VEIJALAINEN, Helsinki (FI)

(21) Appl. No.: 17/278,985

(22) PCT Filed: Sep. 28, 2018
(86) PCT No.: PCT/EP2018/076412

§ 371 Date: Mar. 23, 2021

(51) Int. Cl. H04W 24/10; H04B 17/336; H04W 72/12; H04L 5/00

(52) U.S. Cl. CPC H04W 24/10; H04B 17/336; H04L 5/0051; H04W 72/1263; H04W 72/1231

(57) ABSTRACT

According to an aspect, there is provided a method comprising: determining, by a terminal device of a wireless communication system, one or more distribution measures, wherein distribution comprises one or more of a signal distribution, an interference distribution, mutual information distribution, block error probability distribution or a signal-to-noise-and-interference ratio distribution; producing, by the terminal device, a measurement report that comprises the one or more distribution measures; and transmitting, by the terminal device, the measurement report to an access node of the wireless communication system.

### FIELD

Various embodiments described herein relate to radio link adaptation in a wireless communication system.

### BACKGROUND

A radio link may be a wireless connection between an access node and a terminal device. The radio link may be optimized during the wireless connection. Conditions in the environment may not be stable and thereby affect the conditions for the radio link. Link adaptation may be used to adapt to the change in the environment.

### BRIEF DESCRIPTION OF THE INVENTION

According to an aspect, there is provided a method comprising: determining, by a terminal device of a wireless communication system, one or more distribution measures, wherein distribution comprises one or more of a signal distribution, an interference distribution, mutual information distribution, block error probability distribution or a signal-to-noise-and-interference ratio distribution; producing, by the terminal device, a measurement report that comprises the one or more distribution measures; and transmitting, by the terminal device, the measurement report to an access node of the wireless communication system.

According to another aspect, there is provided a method comprising: receiving, by an access node of a wireless communication system, a measurement report sent by a terminal device of the wireless communication system, wherein the measurement report comprises one or more distribution measures, and wherein distribution comprises one or more of a signal distribution, an interference distribution, mutual information distribution, block error probability distribution or a signal-to-noise-and-interference distribution; performing link adaptation based, at least partly on the one or more distribution measures.

According to another aspect, there is provided an apparatus, comprising: at least one processor, and at least one memory including a computer program code, wherein the at least one memory and the computer program code are configured, with the at least one processor, to cause the apparatus to: determine one or more distribution measures, wherein distribution comprises one or more of a signal distribution, an interference distribution, mutual information distribution, block error probability distribution or a signal-to-noise-and-interference ratio distribution; produce a measurement report that comprises the one or more distribution measures; and transmit the measurement report to an access node of the wireless communication system.

According to another aspect, there is provided an apparatus comprising: at least one processor, and at least one memory including a computer program code, wherein the at least one memory and the computer program code are configured, with the at least one processor, to cause the apparatus to: measure determine one or more distribution measures of a signal-to-noise-and-interference ratio distribution; produce a measurement report that comprises the one or more distribution measures; and transmit the measurement report to an access node of the wireless communication system.

According to another aspect, there is provided an apparatus comprising: at least one processor, and at least one memory including a computer program code, wherein the at least one memory and the computer program code are configured, with the at least one processor, to cause the apparatus to: receive a measurement report sent by a terminal device of a wireless communication system, wherein the measurement report comprises one or more distribution measures, and wherein distribution comprises one or more of a signal distribution, an interference distribution, mutual information distribution, block error probability distribution or a signal-to-noise-and-interference distribution; perform link adaptation based, at least partly, on the one or more distribution measures.

According to another aspect, there is provided a computer program product readable by a computer and, when executed by the computer, configured to cause the computer to execute a computer process comprising: determining, by a terminal device of a wireless communication system, one or more distribution measures, wherein distribution comprises one or more of a signal distribution, an interference distribution, mutual information distribution, block error probability distribution or a signal-to-noise-and-interference ratio distribution; producing, by the terminal device, a measurement report that comprises the one or more distribution measures; and transmitting, by the terminal device, the measurement report to an access node of the wireless communication system.

According to another aspect, there is provided a computer program product readable by a computer and, when executed by the computer, configured to cause the computer to execute a computer process comprising: receiving, by an access node of a wireless communication system, a measurement report sent by a terminal device of the wireless communication system, wherein the measurement report comprises one or more distribution measures, and wherein distribution comprises one or more of a signal distribution, an interference distribution, mutual information distribution, block error probability distribution or a signal-to-noise-and-interference distribution; performing link adaptation based, at least partly, on the distribution measures.

According to another aspect, there is provided an apparatus comprising: at least one processor, and at least one memory including a computer program code, wherein the at least one memory and the computer program code are configured, with the at least one processor, to cause the apparatus to: determine one or more distribution measures, wherein distribution comprises one or more of a signal distribution, an interference distribution, mutual information distribution, block error probability distribution or a signal-to-noise-and-interference ratio distribution; perform based, at least partly, on the one or more distribution measures link adaptation and uplink scheduling; and transmit to a terminal device information regarding the performed link adaptation and uplink scheduling.

According to another aspect, there is provided a method comprising: determining one or more distribution measures, wherein distribution comprises one or more of a signal distribution, an interference distribution, mutual information distribution, block error probability distribution or of a signal-to-noise-and-interference ratio distribution; performing based, at least partly, on the one or more distribution measures link adaptation and uplink scheduling; and transmitting to a terminal device information regarding the performed link adaptation and uplink scheduling.

According to another aspect there is provided a computer program product readable by a computer and, when executed by the computer, configured to cause the computer to execute a computer process comprising: determining one or more distribution measures, wherein distribution comprises one or more of a signal distribution, an interference distribution, mutual information distribution, block error probability distribution or of a signal-to-noise-and-interference ratio distribution; performing based, at least partly, on the one or more distribution measures link adaptation and uplink scheduling; and transmitting to a terminal device information regarding the performed link adaptation and uplink scheduling.

### LIST OF DRAWINGS

In the following, the invention will be described in greater detail with reference to the embodiments and the accompanying drawings, in which

FIG. 1 illustrates a wireless access network to which embodiments of the invention may be applied;

FIG. 2 illustrates various 5G use cases

FIG. 3 is a graph illustrating the effect of SINR distribution on performance.

FIG. 4 is a graph illustrating signalling between an access node and a terminal device.

FIG. 5 is a flow chart illustrating operations performed by an access node.

FIG. 6 is a flow chart illustrating operations performed by a terminal device.

FIG. 7 is a block diagram illustrating an example apparatus.

### DESCRIPTION OF EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Embodiments described herein may be implemented in a communication system, such as in at least one of the following: Global System for Mobile Communications (GSM) or any other second generation cellular communication system, Universal Mobile Telecommunication System (UMTS, 3G) based on basic wideband-code division multiple access (W-CDMA), high-speed packet access (HSPA), Long Term Evolution (LTE), LTE-Advanced, a system based on IEEE 802.11 specifications, a system based on IEEE 802.15 specifications, and/or a fifth generation (5G) mobile or cellular communication system. The embodiments are not, however, restricted to the system given as an example but a person skilled in the art may apply the solution to other communication systems provided with necessary properties.

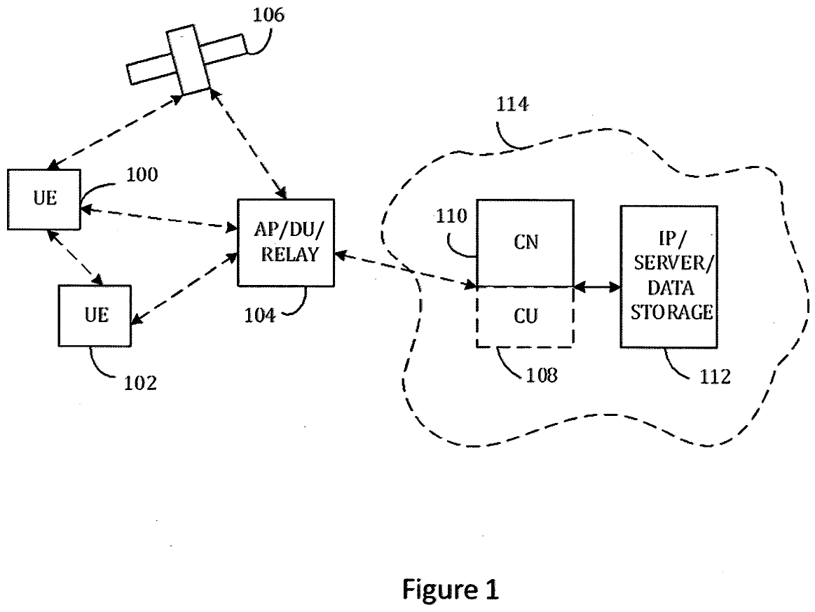

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilise cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called, a terminal device, a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being integratable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilise services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

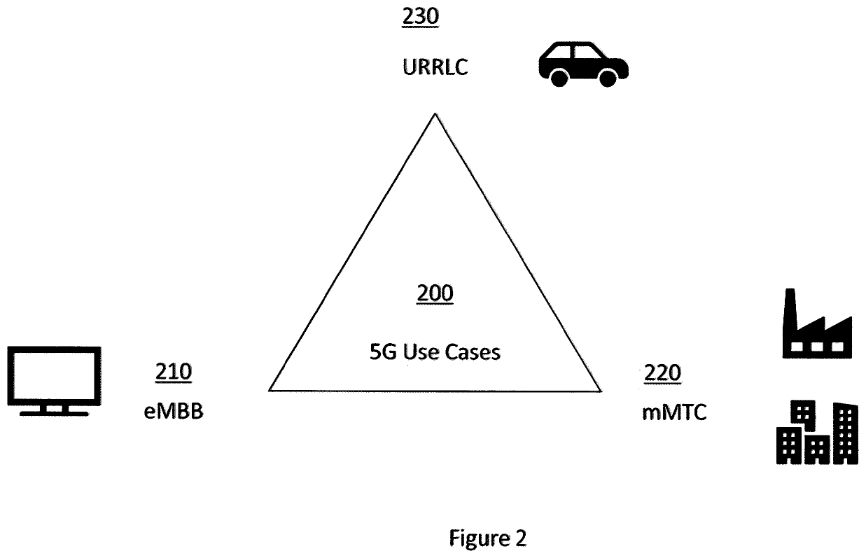

An increasing amount of terminal devices are connecting to wireless communication networks. Users of the terminal devices are also expecting real time, on demand and all online types of services which means the demand for the wireless communication network are increased. The increasing demands and use cases related to those demands that are to be met by the envisaged 5G are illustrated in FIG. 2. Use case related to 5G (200) can be classified to three different categories: Enhanced, Mobile Broadband, eMBB (210), Massive Machine Type Communications, mMTC (220) and Ultra-reliable and Low-latency Communications, URLLC (230).

eMBB (210) can be considered as an evolution to 4G. eMBB (210) comprises support for uses cases that require high bandwidths. Examples of such use cases are virtual reality and augmented reality related use cases as well as high-resolution video streaming use cases. For example, enabling streaming of 360-degree video content and streaming of truly immersive virtuality content are use cases that are to be supported by eMBB (210). The primary purpose for eMBB (210) therefore is to provide better data rate to the end user.

mMTC (220) is targeted to enable connectivity for use cases such as smart homes and smart cities. In the context of mMTC (220) a vast number of terminal devices may be connected to an access node, but not all of them are active at the same time. Therefore, it is not feasible to allocate resource before a connection is established, but instead resources are provided such that those can be shared using random access. A further example of mMTC (220) use case is a scenario in which a vast number of IoT devices need to be connected but send only small payloads of data in a sporadic manner. This includes use cases such as providing sensor data from a building as well as measuring and monitoring.

URLLC (230) is targeted to enable delay-sensitive service use cases such as autonomous driving, remote control, factory automation and vehicle-to-vehicle communication. URLLC (230) is to support low-latency transmissions of small payloads while having high reliability requirements.

In 5G, all three categories, eMBB (210), mMTC (220) and URLLC (230) coexist within the same RAN architecture. To enable the coexistence, network slicing is utilized. In network slicing, the resources, such as network computing, storage and communication resources, are allocated among the active services such that isolation of the services and their performance levels are guaranteed. Network slicing may be achieved by utilizing the principles behind software defined networking, SDN, and network functions virtualisation, NFV, that can be used in fixed networks. Thereby multiple virtual networks that all share the same physical infrastructure can be created. Each virtual network is then optimized to provide the resources and network topology for the use case that is to be provided by that virtual network. Since each virtual network is isolated from other virtual networks the user experience of the virtual network is as if it was a physically separate network.

In the URLLC (230) instant access and errorless data transmission are required. One way to describe the target level for the errorless data is so called block error rate, BLER, which is defined as the ratio of the number of erroneous blocks received to the total number of blocks sent. In a 4G BLER of 0.01 is tolerated while in URLLC the required BLER is 0.00001 and the packets can be subjected to 1 ms latency constraint.

Conditions for a radio link between an access node and a terminal device in a wireless communication network may not stay stable but vary due to various factors such as pathloss, interference due to signals coming from other transmitters, sensitivity of the receiver and available power margin. Therefore, the access node is provided with information regarding those conditions. This information is provided by the terminal device which may also provide a suggestion regarding how the access node should modify the transmitting for next transmission. The above-mentioned operation, link adaptation, is the ability to adapt to the radio link conditions such that the target requirements including BLER can be achieved. The link adaptation may be achieved by modifying the modulation and coding scheme, MCS, which defines how the information to be transmitted is mapped into the waveforms transmitted by the access node. The terminal device may, in some example embodiments, provide a suggestion for the MCS to be used by providing a certain value for a channel quality indicator, CQI, that is then transmitted to the access node.

In some examples embodiments, the link adaptation is adjusted according to an observed mean signal-to-noise-and-interference, SINR. SINR is used to measure the quality of the wireless connection taking into account factors such as path loss, background noise and interfering strength of other simultaneous transmissions. In addition to observing the mean SINR, also counting ACK/NACK messages is used for the link adaptation. An ACK message is used to indicate a successful transmission of a payload and NACK to indicate a failed transmission of a payload.

Counting ACK/NACK messages may be time consuming in the context of large number of statistics. For example, if the target BLER is 1e-6 and at least 100 error events are to be observed in order to get a useful estimation of the performance, 100 million packets would then have to be collected to be able to evaluate the actual performance. In some example embodiments this approach could be useful while in some example embodiments the measurement time is long enough for the channel conditions to change before the measurement can be completed.

In 5G it is envisaged that the channel state information, CSI, framework would comprise, as information to be reported to the access node by the terminal device, channel quality indicator, CQI, that may be used to indicate the current conditions of the channel, precoding matrix indicator, PMI, that is a value computed on the fly and which may be used to optimize resource allocation among various terminal devices requesting services from the access node, CSI-RS resource indicator, CRI, that may be used to indicate the preferred beam, synchronization signal/physical broadcast channel, SS/PBCH, block resource indicator, SSBRI, layer indicator, L1, rank indicator, RI, and/or L1-RSRP. It is to be noted that these are examples of what is envisaged currently, and changes may occur to the CSI framework. It is also currently envisaged to have, in the context of 5G, a CQI table for less efficient but more robust operation. CSI reports indicate the mean SINR that is measured from a specific resource and therefore the adjustments made are focused towards where the interference was measured. CSI may further be limited to a particular bandwidth and thereby may not address the full bandwidth of the system. If the full bandwidth of the system was addressed, that would require more power, which could be too much for some terminal devices like mobile phones.

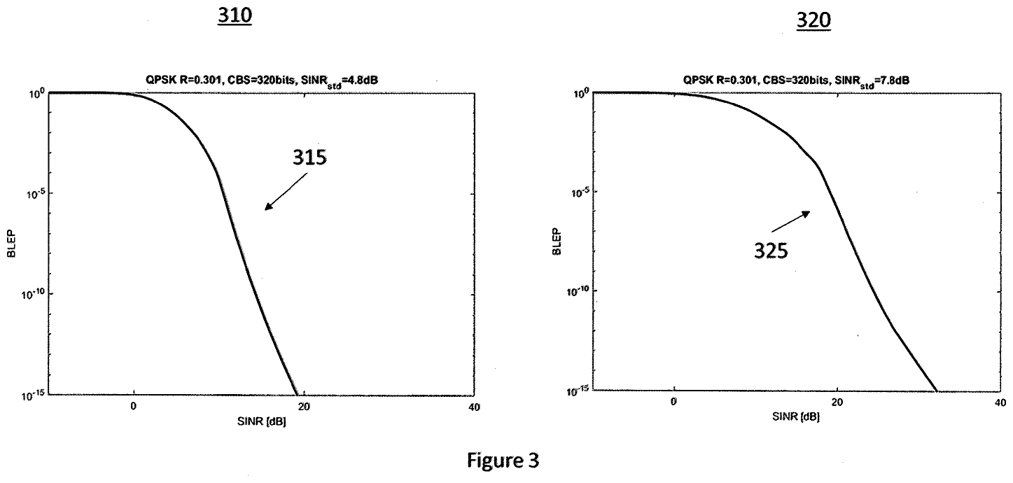

While the mean SINR is useful information, it is to be noted that the distribution of the SINR values over multiple resource elements in frequency and in time domain matters as well. A resource element, as referred to herein, refers to an element which carries one symbol from a selected modulation alphabet (which can be a phase- and/or amplitude modulation, e.g. BPSK, QPSK, 16QAM, 64QAM, 256QAM) and transmitting one message may require multiple resource elements and modulation symbols. FIG. 3 illustrates this aspect. Graph (310) of FIG. 3 shows an example performance (315) experienced by a 320 bits message with modulation coding scheme of QPSK R=0.301. Graph (320) illustrates the performance (325) when the message is the same, the modulation coding scheme is also the same but the standard deviation of the SINR changes. While the standard deviation of the SINR is 4.8 dB (indoor hotspot channel model, InH, where signal and interference are both in LOS conditions) in the graph (310), the standard deviation of the SINR in graph (320) is 7.8 dB (InH, where signal and interference are both in NLOS conditions). This means that on the average there is a performance difference for the same message using the same modulation coding scheme and having the same mean SINR but different SINR distribution. This means that the information obtained from mean SINR is not as comprehensive as the information that can be obtained from SINR distribution information.

In the context of URLLC, the reliability requirements are very high. In order to meet those high requirements, it is beneficial to have as clear understanding of the channel conditions as possible so that the link adaptation process can function as efficiently as possible. To be able to perform efficient link adaptation methods and/or methods based directly on them in the URLLC context, the following input is needed: target BLER, which is a system level requirement and thereby a known parameter, code block size, which is known by the scheduler and thereby a known parameter, mean SINR, which is reported by the terminal device, latency requirement and HARQ-retransmission allowance, which may be used for error control, are system level requirements and thereby known parameters, and finally one or more SINR distribution measures is to be reported by the terminal device. It is to be noted that the one or more SINR distribution measures may be achieved in various manners and that one or more interference distribution measures and one or more signal distribution measures may be determined and reported by the terminal device either together or separately. The terminal device may also determine distribution of block error probability, BLEP, and/or distribution of mutual information, MI, which may be in addition or as an alternative to the one or more SINR distribution measures. It is to be noted that determining may comprise measuring, detecting or calculating.

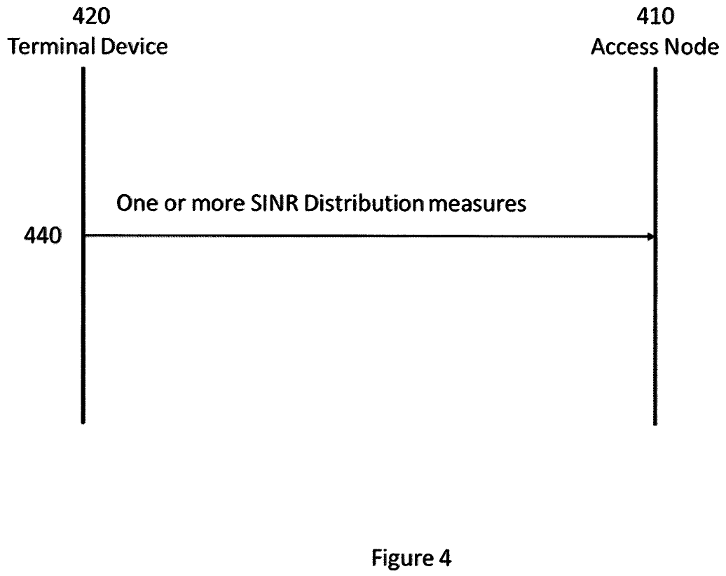

FIG. 4 illustrates the reporting of the one or more SINR distribution measures. Access node (410) in this example is a gNodeB, but it could be any other type of suitable access node as well. Terminal device (420) could be any device that is capable of connecting to the access node (410) such as a mobile phone, tablet computer, a drone or a vehicle. In order to connect to the access node (410) the terminal device (420) and the access node (410) need to have an established radio connection such as a radio resource control (RRC) connection. Once the connection has been established, there can be RRC messaging between the access node (410) and the terminal device (420). The access node (410) may, in some example embodiments, send an RRCConnectionReconfiguration (not shown in the FIG. 4) message to the terminal device (420). In that message there may be an element in measurement objects which is meant for one or more SINR distribution measures.

The terminal device (420) may then respond using, for example, a RRCConnectionReconfigurationComplete message that includes a measurement report from the terminal device (420). The measurement report includes the one or more SINR distribution measures (440). In order for the link adaptation to utilize the one or more SINR distribution measures, the terminal device (420) is to report the one or more SINR distribution measures to the access node (410). Although the reporting may, in some example embodiments, be part of the RRC messaging between the access node (410) and the terminal device (420), other ways could also be utilized to report the SINR distribution measurement (440). In some example embodiments the one or more SINR distribution measures may be transmitted via a physical uplink control channel, PUCCH or a physical uplink shared channel, PUSCH and/or as a part of a CSI report.

In some alternative example embodiments, the terminal device is configured to determine one or more signal distribution measures and transmit the one or more signal distribution measures to the access node. Distribution measures determined comprise measures from distributions such as a signal distribution, an interference distribution, mutual information distribution, block error probability distribution or a signal-to-noise-and-interference ratio distribution. Thereby, the terminal device could, in some example embodiments, then also, separately from determining and transmitting the one or more signal distribution measures, determine one or more interference distribution measures and transmit the one or more interference distribution measures to the access node. The access node would then combine the received one or more signal distribution measures and the received one or more interference distribution measures and perform link adaptation based on the combination.

Further in some alternative example embodiments, the terminal device determines one or more interference distribution measures and combines them with a reference signal received quality, RSRQ, measure, from which interference levels are derived and this information is then transmitted to the access node. An advantage of this example embodiments is that link adaptation accuracy may be improved.

In another alternative example embodiment, the terminal device determines one or more signal distribution measures and combines them with a reference signal received power, RSRP, measure and this information is then transmitted to the access node. An advantage of this example embodiments is that link adaptation accuracy may be improved.

In some alternative example embodiments, the terminal device determines one or more mutual information, MI, distribution measures. The terminal device may in this example embodiment define, based on the modulation and coding scheme of a received signal MI per symbol, which is a function of SINR, or MI per bit, which is a function of SINR and modulation and coding scheme, and transmit that information to the access node. This way part of the link adaptation process is done by the terminal device and the access node may use the transmitted information comprising MI distribution measures for deciding the code rate for the modulation and coding scheme used. For other modulation and coding schemes the access node may perform a reverse mapping first and then perform link adaptation.

In yet another example embodiment, the terminal device determines one or more SINR distribution measures and based on those derives a resulting block error probability, BLEP, distribution, which is then transmitted to the access node, in addition or instead of the one or more SINR distribution measures. The terminal device may derive the resulting BLEP distribution based on for example from a series of look-up tables with multiple look-up tables for different code block sizes and SINR standard deviation values. MI may be used to derive BLEP since BLEP is a function of code rate and codeword size. In some example embodiments, after deriving the resulting BLEP distribution, the terminal device may transmit information regarding the resulting BLEP distribution to the access node. It is to be noted that the resulting BLEP distribution may be considered as distribution of a signal quality indicator. Other examples of signal quality indicators comprise signal interference, SINR, mutual information or any other indicator that is associated with signal quality. Thus, the terminal device transmits information regarding distribution of a signal quality indicator. This information may be part of one or more distribution measures comprised in a measurement report that the terminal device transmits to the access node. The access node may the use the information regarding distribution of a signal quality indicator as a recommendation for link adaptation but make the final decision regarding the link adaptation to be performed. For link adaptation purposes, statistics may be collected by sampling large numbers of channel realizations using specified SINR distributions and repeating the procedure for different code block sizes.

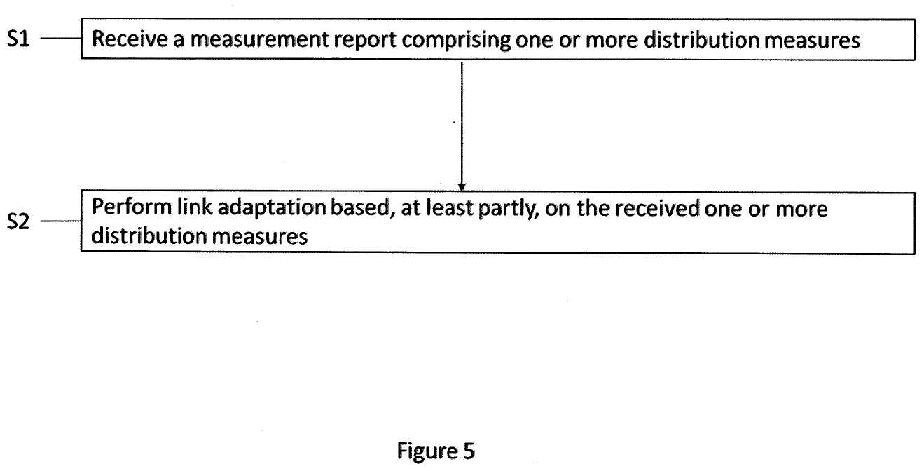

FIG. 5 is a flow chart that illustrates an example of the operations performed by an access node such as the access node (410). In step S1 of the flow chart, the access node receives a measurement report from a terminal device such as the terminal device (420). The measurement report received comprises one or more distribution measures, and wherein distribution comprises one or more of a signal distribution, an interference distribution, mutual information distribution, block error probability distribution or a signal-to-noise-and-interference ratio distribution a SINR distribution or distribution of any other suitable signal quality metric. In step S2, link adaptation is performed based, at least partly, on the received one or more distribution measures. In some example embodiments, the access node performs link adaptation every time when there is a transmission of user-plane data.

The access node may, in some example embodiments, receive the measurement report as part of the RRC messaging as was described in the context of FIG. 4. It is to be noted that also other ways of transmitting the measurement report from the user terminal to the access node could be utilized as has also been described above. If the one or more distribution measures are received as part of the measurement report sent, the access node may provide measurement report transmitting configuration that configures aspects related to the one or more distribution measures that are to be reported to the access node by the terminal device. Such aspects may comprise objectives to be measured, like CSI-RS, activation or deactivation of the measurement, way of reporting and way of determining, which may comprise calculating, the one or more SINR distribution measures.

The one or more SINR distribution measures may be reported as SINR standard deviation or as one or more SINR percentiles, for example 0.1 percentile, 1 percentile or 5 percentile. The SINR standard deviation may be reported using 6 bits for example, which means 64 values such as [0:0.2:12.6] dB. As for SINR percentiles, the applicable one or more percentiles may be configured, for example in the measurement report transmitting configuration, by the access node, this then informs the configurations to the terminal device. The terminal device then reports the SINR-value of defined percentiles. For example, with 6 bits and 1 dB granularity the reporting could be [−32:1:31]. Thus, in some example embodiments unit of the SINR-samples and thereby also the unit of the standard deviation of the SINR-distribution is decibels, dB. It is to be noted that the mean SINR value is also included in the measurement reports transmitted by the terminal device to the access node.

The measurement report including the one or more distribution measures may be transmitted by the terminal device periodically, in accordance with the measurement report transmitting configuration received from the access node, in some example embodiments. This would help to ensure the requirements of a URLLC use case can be met. The period for the periodic reporting could be set by the access node. As various terminal devices may have various needs due to difference in mobility and also various use cases may have various needs, the access node may define different periods for different terminal devices and/or use cases for reporting the one or more distribution measures.

In some other examples, in accordance with the measurement report transmitting configuration received from the access node the measurement report including the one or more distribution measures may be transmitted by the terminal device based on events. For example, when there is a change is the channel conditions or if the access node requests the measurement report, an event-based reporting of the one or more distribution measures could be triggered. Additionally or alternatively, a change in the mean SINR value and/or a change in the SINR distribution may trigger an event-based transmitting of the one or more distribution measures.

Advantages that may be achieved by utilizing the one or more distribution measures in link adaptation include the ability to make timely actions by the access node in order to meet the tight BLER requirements of the URLLC. Link adaptations performed by the access node may better target the actual conditions of the channel since SINR distribution provides more accurate information compared to mean SINR. Also, when compared to collecting ACK/NACK messages and performing link adaptations based on those, time is saved in some example embodiments. With ACK/NACK messages, the feedback based on which the link adaptation could take too long up to the point of not being feasible anymore. With low latency requirements of the URRLC, ACK/NACK based feedback could be problematic in some example embodiments. A further advantage is that if the measurement report is received using the RRC messaging prior to activating a service, the necessary resources needed could be better planned and allocated. Another advantage that may be achieved is that the access node can derive proper link adaptation decisions for any given code block size instead of assuming a fixed code block size.

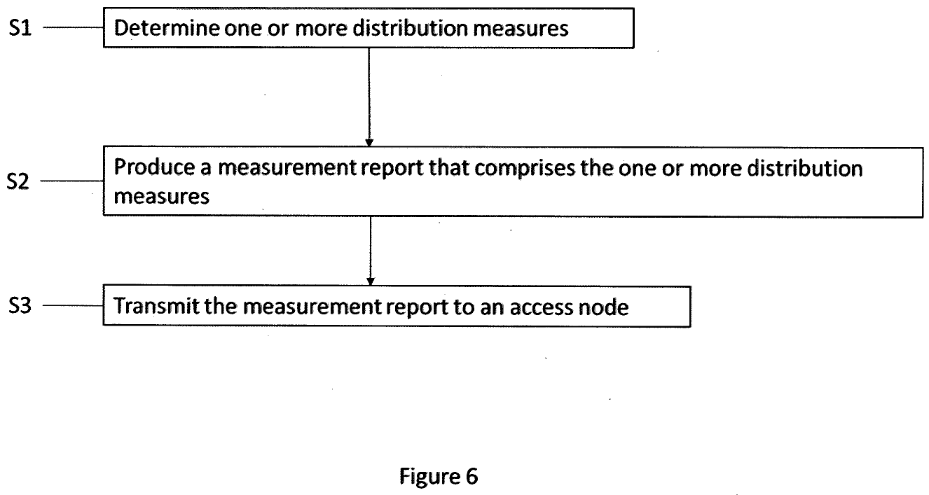

FIG. 6 is a flow chart that illustrates operations performed by the terminal device such as the terminal device (420). In step S1 the terminal device determines the one or more distribution measures, wherein distribution comprise one or more of a signal distribution, an interference distribution, mutual information distribution, block error probability distribution or a signal-to-noise-and-interference ratio, SINR, distribution or distribution of any other suitable signal quality metric. The one or more distribution measures may be, in some example embodiments, determined in accordance with measurement report transmitting configuration received from the access node. The one or more SINR distribution measures may be obtained in some examples by measuring the demodulation reference signal, DMRS, that is broadcasted over the whole bandwidth. In some other examples, the one or more SINR distribution measures may be obtained based on one or more of the following: synchronization signal blocks, channel-state information reference signal blocks, beamformed physical downlink control channel allocated to the terminal device or to a group of terminal devices in which group the terminal device is comprised, beamformed physical downlink shared channel allocated to the terminal device or to a group or terminal devices in which the group the terminal device is comprised. In addition, it is also possible that SINR distributions over one or multiple sub-bands or bandwidth-parts are measured and reported as part of the one or more SINR distribution measures.

After the distribution measures are obtained, the terminal device produces a measurement report that comprises the one or more distribution measures as is illustrated in step S2. In step S3 the measurement report is transmitted to the access node. As was described above in the context of FIG. 5, the measurement report may be transmitted as part of the RRC messaging as was described in the context of FIG. 4. It is to be noted that any other suitable way of reporting the one or more distribution measures to the access node may also be used.

Like was described in the context of FIG. 5, the one or more SINR distribution measures may be reported as SINR standard deviation or as one or more SINR percentiles, for example 0.1 percentile, 1 percentile or 5 percentile. The SINR standard deviation may be reported using 6 bits for example, which means 64 values such as [0:0.2:12.6] dB. As for SINR percentiles, the applicable one or more percentiles can be configured by the access node to the terminal device. The terminal device then reports the SINR-value of defined percentiles. For example, with 6 bits and 1 dB granularity the reporting could be [−32:1:31]. It is to be noted that the mean SINR value is also included in the measurement reports transmitted by the terminal device to the access node.

The measurement report including the one or more distribution measures may be transmitted by the terminal device periodically in some examples. This would help to ensure the requirements of a URLLC use case can be met. The period for the periodic reporting could be set by the access node. As various terminal devices may have various needs due to difference in mobility and also various use cases may have various needs, the access node may define different period for different terminal devices and/or use cases.

In some other examples, the measurement report including the one or more distribution measures may be transmitted by the terminal device based on events. For example, when there is a change in the channel conditions or if the access node requests the measurement report.

It is to be noted that in addition to a terminal device determining, by way of measuring and/or calculating for example, one or more distribution measures an access node may also be capable of determining, by way of measuring and/or calculating for example, the one or more distribution measures. The access node may then, in some example embodiments, perform link adaptation and/or uplink scheduling based on the determined one or more distribution measures and transmit to a terminal device information regarding the performed link adaptation and uplink scheduling. The information may be, for example, in the form of parameters relevant to the link adaptation and/or uplink scheduling. The access node may determine the one or more distribution measures based on, at least partly, for example uplink sounding reference symbols and/or uplink user plane data.

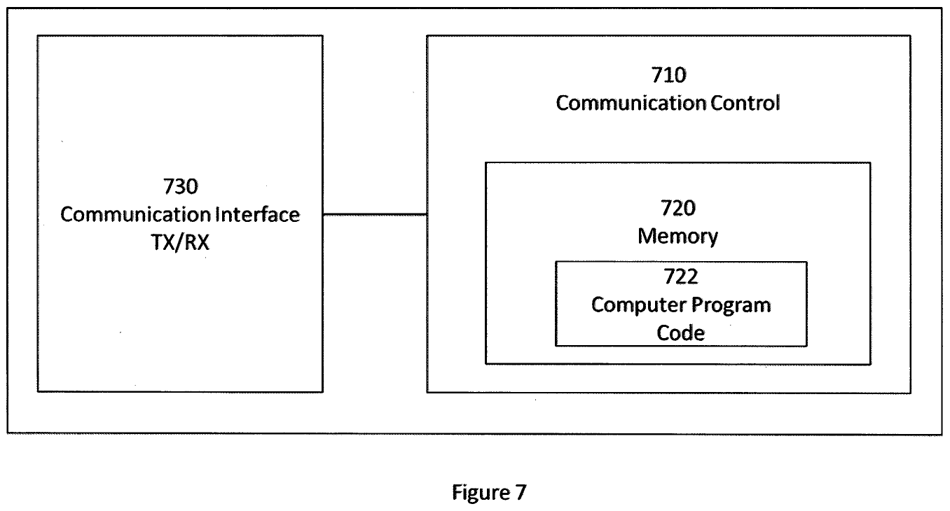

FIG. 7 illustrates an apparatus applicable to the terminal device. The apparatus of FIG. 7 may be the terminal device, or the apparatus may be comprised in the terminal device. The apparatus may be, for example, a circuitry or a chipset suitable for the terminal device to realize the described embodiments. The apparatuses of FIG. 7 may be an electronic device comprising electronic circuitries and the apparatus may comprise a communication control circuitry 710 such as at least one processor, and at least one memory 720 including a computer program code 722 wherein the at least one memory and the computer program code are configured, with the at least one processor, to cause the apparatus to carry out any one of the embodiments of the terminal device described above.

The memory 720 may be implemented using any suitable data storage technology, such as semiconductor based memory devices, flash memory, magnetic memory devices and systems, optical memory devices and systems, fixed memory and removable memory. The memory may comprise a configuration database for storing configuration data for use in the transmissions.

The apparatus may further comprise a communication interface (TX/RX) 730 comprising hardware and/or software for realizing communication connectivity according to one or more communication protocols. The communication interface 730 may provide the apparatus with communication capabilities to communicate in a cellular communication system and/or in another wireless network. The communication interface 730 may comprise components such as an amplifier, filter, frequency-converter, (de)modulator, and encoder/decoder circuitries and one or more antennas. The communication interface 730 may comprise radio interface components providing the apparatus with radio communication capability in one or more wireless networks.

It is to be noted that an apparatus applicable to an access node may comprise a communication control circuitry such as at least one processor, and at least one memory including a computer program code, wherein the at least one memory and the computer program code are configured, with the at least one processor, to cause the apparatus to carry out any one of the embodiments of the access node described above.

The memory may be implemented using any suitable data storage technology, such as semiconductor based memory devices, flash memory, magnetic memory devices and systems, optical memory devices and systems, fixed memory and removable memory. The memory may comprise a configuration database for storing configuration data. For example, the configuration database may store current neighbour cell list and, in some embodiments, validity windows computed for the detected neighbour cells. The configuration database may also store trajectories of the mobile access nodes registered to the wireless communication system. Such information may enable the network node to determine the timings when the mobile access nodes are so close to the network node that addition of new links to the mobile access nodes is possible for terminal devices served by the network node.

The apparatus may further comprise a communication interface (TX/RX) comprising hardware and/or software for realizing communication connectivity according to one or more communication protocols. The communication interface may provide the apparatus with radio communication capabilities to communicate in the wireless communication system. The communication interface may, for example, provide a radio interface to terminal devices.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. The above-described embodiments of the circuitry may also be considered as embodiments that provide means for carrying out the embodiments of the methods or processes described in this document.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, microcontrollers, microprocessors, other electronic units designed to perform the functions described herein, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium.

1. A method comprising:
determining, by a terminal device of a wireless communication system, one or more distribution measures, wherein distribution comprises one or more of a signal distribution, an interference distribution, mutual information distribution, block error probability distribution or a signal-to-noise-and-interference ratio distribution;
producing, by the terminal device, a measurement report that comprises the one or more distribution measures; and
transmitting, by the terminal device, the measurement report to an access node of the wireless communication system.

2. A method according to claim 1, wherein the one or more distribution measures comprise standard deviation of signal-to-interference-and-noise ratio distribution.

3. A method according to claim 1, wherein the one or more measures comprise one or more percentiles of the signal-to-interference-and-noise ratio distribution.

4. (canceled)

5. A method according to claim 3, wherein the one or more percentiles of the signal-to-interference-and-noise ratio reporting comprises:
the terminal device receiving, from the access node, configuration regarding applicable signal-to-interference-and-noise ratio percentiles, and
the terminal device reporting, to the access node, the signal-to-interference-and-noise ratio of the applicable percentiles.

6. A method according to claim 1, wherein the transmitting, by the terminal device, the measurement report to the access node of the wireless communication system further comprises transmitting the measurement report, according to measurement report transmitting configuration received from the access node, either periodically or in response to detecting a change in channel conditions and/or receiving a measurement request from the access node.

7. A method according to claim 6, wherein the detected change in the channel conditions comprises a change in the signal-to-noise-and-interference ratio distribution.

8. A method according to claim 1, wherein the one or more distribution measures comprises one or more measures of signal-to-noise-and-interference ratio distribution that are determined, by the terminal device, based on one or more of: synchronization signal blocks, channel-state information reference signal blocks, beamformed physical downlink control channel allocated to the terminal device or to a group of terminal devices in which group the terminal device is comprised, beamformed physical downlink shared channel allocated to the terminal device or to a group of terminal devices in which the group the terminal device is comprised.

9. A method according to claim 1, wherein the one or more distribution measures comprises one or more measures of signal-to-noise-and-interference ratio distribution that are determined, by the terminal device, based on a demodulation reference signal that is broadcasted over the whole bandwidth.

10.-11. (canceled)

12. A method according to claim 1, wherein the one or more distribution measures comprises one or more measures of signal-to-noise-and-interference ratio distribution and the method further comprises;
deriving, by the terminal device, a resulting block error probability from the one or more signal-to-noise-and-interference ratio distribution and transmitting, by the terminal device, the resulting block error probability as part of the measurement report to the access node.

13.-17. (canceled)

18. An apparatus, comprising:
at least one processor, and
at least one memory including a computer program code, wherein the at least one memory and the computer program code are configured, with the at least one processor, to cause the apparatus to:
determine one or more distribution measures, wherein distribution comprises one or more of a signal distribution, an interference distribution, mutual information distribution, block error probability distribution or a signal-to-noise-and-interference ratio distribution;
produce a measurement report that comprises the one or more distribution measures; and
transmit the measurement report to an access node of the wireless communication system.

19. An apparatus according to claim 18, wherein the one or more distribution measures comprise standard deviation of the signal-to-noise-and-interference ratio.

20. An apparatus according to claim 18, wherein the one or more distribution measures comprise one or more percentiles of the signal-to-interference-and-noise ratio distribution.

21. (canceled)

22. An apparatus according to claim 20, wherein the one or more signal-to-noise-and-interference ratio percentiles reporting comprises:
receive, from the access node, configuration regarding applicable signal-to-noise-and-interference ratio percentiles, and
report, to the access node, the signal-to-noise-and-interference ratio of the applicable percentiles.

23. An apparatus according to claim 18, wherein transmit the measurement report to the access node of the wireless communication system further comprises:
transmit the measurement report, according to measurement report transmitting configuration received from the access node, either periodically or in response to detecting a change in channel conditions and/or receiving a measurement request from the access node.

24. An apparatus according to claim 23, wherein the detected change in the channel conditions comprises a change in the signal-to-noise-and-interference ratio distribution.

25.-29. (canceled)

30. An apparatus, comprising:
at least one processor, and
at least one memory including a computer program code, wherein the at least one memory and the computer program code are configured, with the at least one processor, to cause the apparatus to:
receive a measurement report sent by a terminal device of a wireless communication system, wherein the measurement report comprises one or more distribution measures, and wherein distribution comprises one or more of a signal distribution, an interference distribution, mutual information distribution, block error probability distribution or a signal-to-noise-and-interference distribution;
perform link adaptation based, at least partly, on the one or more distribution measures.

31. An apparatus according to claim 30, wherein prior to, receive the measurement report comprising the one or more distribution measures, the apparatus has sent, to the terminal device, a radio resource control connection reconfiguration message comprising a measurement object element that is dedicated to the one or more distribution measures.

32. An apparatus according to claim 31 wherein the radio resource control connection reconfiguration message sent by the apparatus has configurations regarding one or more of the following aspects related to the one or more distribution measures: activation or deactivation of the measurement, objectives to be measured, ways to calculate the signal-to-noise-and-interference distribution measurement and way of reporting the signal-to-noise-and-interference distribution measurement.

33. An apparatus according to claim 30, wherein the apparatus is further configured to:
transmit to the terminal device a measurement transmitting configuration comprising instructions, to the terminal device, to transmit the measurement report based on changed detected, by the terminal device, in the signal quality distribution.

34. (canceled)

35. A non-transitory computer readable medium comprising program instructions for causing an apparatus to perform at least the method of claim 1.

36.-41. (canceled)
